(19) United States
(12) Patent Application Publication
(10) Pub. No.: US 2025/0356460 A1
(43) Pub. Date: Nov. 20, 2025

(54) METHOD, APPARATUS, AND SYSTEM FOR RECONFIGURABLE AND LOW-POWER CONVOLUTIONS

(71) Applicants: UNIVERSITY OF FLORIDA RESEARCH FOUNDATION, INCORPORATED, Gainesville, FL (US); THE GOVERNMENT OF THE UNITED STATES, REPRESENTED BY THE SECRETARY OF THE NAVY, Arlington, VA (US)

(72) Inventors: Sanjeev Jagannatha KOPPAL, Gainesville, FL (US); Hannah KIRKLAND, Gainesville, FL (US); Isaac John SLEDGE, Gainesville, FL (US)

(21) Appl. No.: 19/090,939

(22) Filed: Mar. 26, 2025

Related U.S. Application Data
(60) Provisional application No. 63/647,916, filed on May 15, 2024.

(51) Int. Cl. G06T 5/20; G06V 10/771

(52) U.S. Cl. CPC G06T 5/20; G06V 10/771; G06T 2207/20081

(57) ABSTRACT

A method, apparatus, and system for deep learning inference are provided including a system that employs inexpensive micro-displays, an active pixel sensor, and a computer to perform lensless incoherent convolutions at the speed of light. An apparatus is provided including processing circuitry and at least one memory including computer program code, the at least one memory and the computer program code configured to, with the processing circuitry, cause the apparatus to at least: receive feature maps of an image; receive one or more convolutional kernel; provide for display of patterned light corresponding to the feature maps; apply the one or more convolutional kernel; capture spatial convolutions at a corresponding imaging plane; and provide the spatial convolutions as training data for deep learning.

### CROSS-REFERENCE TO RELATED APPLICATIONS

This application claims priority to U.S. Provisional Application No. 63/647,916, filed on May 15, 2024, the contents of which are hereby incorporated by reference in their entirety.

### STATEMENT OF GOVERNMENT FUNDING

This invention was made with government support under N00014-23-1-2363 awarded by the US NAVY OFFICE OF NAVAL RESEARCH. The government has certain rights in this invention.

### TECHNOLOGICAL FIELD

An example embodiment of the present disclosure relates to a method, apparatus, and system for deep learning inference using a low-power inexpensive platform, and more specifically, to a system that employs inexpensive micro-displays, an active pixel sensor, and a computer to perform lensless incoherent convolutions at the speed of light.

### BACKGROUND

Optical processing has been well-studied and cross-disciplinary efforts have enabled the implementation of neural networks in optical hardware resulting in a mature sub field with substantial documentation. The resurgence of neural networks in computer vision and other fields has led to new impacts. Deep diffractive neural networks use diffraction across a series of specially engineered surfaces to construct task-specific models. Feed forward networks with millions of neurons and hundreds of billions of connections across fully connected layers have been fabricated in this way. These approaches are full-optics approaches that often have light attenuation effects that usually limit the number of layers. Further, most deep-diffraction neural networks do not have non-linear capabilities and thus can only realize linear neural activation functions.

Optical processing with optical fibers attempt to mimic pathways found in the brain. Multi-mode fibers have also seen extensive use for recognition tasks. These have been combined with optical reservoir computing systems to achieve high throughput rates. These approaches require powerful lasers and do not provide low-power or inexpensive solutions.

### BRIEF SUMMARY

Embodiments of the present disclosure provide a method, apparatus, and system for deep learning inference using a low-power inexpensive platform, and more specifically, to a system that employs inexpensive micro-displays, an active pixel sensor, and a computer to perform lensless incoherent convolutions at the speed of light. Embodiments provided herein include an apparatus including processing circuitry and at least one memory including computer program code, the at least one memory and the computer program code configured to, with the processing circuitry, cause the apparatus to at least: receive feature maps of an image; receive one or more convolutional kernel; provide for display of patterned light corresponding to the feature maps; apply the one or more convolutional kernel; capture spatial convolutions at a corresponding imaging plane; generate new feature maps from the captured spatial convolutions; and provide the spatial convolutions as training data for deep learning. The apparatus of some embodiments is further configured to: provide for display of patterned light corresponding to the new feature maps; apply the one or more convolutional kernel; capture new spatial convolutions at a corresponding imaging plane; and provide the new spatial convolutions as training data for deep learning.

According to some embodiments, causing the apparatus to provide for display of patterned light corresponding to the feature maps includes causing the apparatus to provide for display of the patterned light on a backlit display. According to certain embodiments, causing the apparatus to apply the one or more convolutional kernel includes causing the apparatus to apply one or more convolutional kernel at a transparent non-emissive display. According to some embodiments, causing the apparatus to capture the spatial convolutions at the corresponding imaging plane includes causing the apparatus to capture the spatial convolutions at a processor.

The apparatus of some embodiments is further caused to train at least one machine learning model based, at least in part, on the spatial convolutions. The machine learning model of an example embodiment includes a facial detection model. Causing the apparatus of some embodiments to receive the feature maps of the image includes causing the apparatus to pre-process the feature maps and load the feature maps onto a display module. According to some embodiments, causing the apparatus to receive the one or more convolutional kernel includes causing the apparatus to pre-process the one or more convolutional kernel and load the one or more convolutional kernel onto another display module. Causing the apparatus of some embodiments to provide the spatial convolutions as training data for deep learning includes causing the apparatus to post-process the captured spatial convolutions for compatibility with at least one machine learning model.

Embodiments provided herein include a system for deep network inference including: a back-lit micro display; a transparent display; an active pixel sensor; and a processor, where the back-lit micro display provides for display of a feature map of a captured image, where the transparent display provides for display of a kernel, and where the active pixel sensor captures a convoluted and transformed response. The deep learning model of some embodiments includes a facial detection model. The back-lit micro display, the transparent display, and the active pixel sensor are, in some embodiments, arranged along an optical axis. According to some embodiments, the active pixel sensor detects the feature map of the captured image displayed on the back-lit micro display through the transparent display displaying the kernel to capture the convoluted and transformed response.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 illustrates a block diagram of an example hybrid electro-optical convolutional device according to an example embodiment of the present disclosure;

FIG. 2 illustrates optical convolution for an output channel according to an example embodiment of the present disclosure;

FIG. 3 is a table of variables employed in the design of devices according to an example embodiment of the present disclosure;

FIG. 4 illustrates the effect on classification due to simulated Poisson noise effect on a variety of deep networks including standard architectures according to an example embodiment of the present disclosure;

FIG. 5 depicts a table representing the baseline software binary CNN test accuracies according to an example embodiment of the present disclosure;

FIG. 6 illustrates the combined optical outputs from an example device compared to the software outputs of convolutions from the BCNN CIFAR-10 model according to an example embodiment of the present disclosure;

FIG. 7 illustrates one row from an array for a particular input and compared to individual convolutions according to an example embodiment of the present disclosure;

FIG. 8 illustrates a ray diagram of an example embodiment of the disclosed system coupled with normal camera optics according to an example embodiment of the present disclosure;

FIG. 9 illustrates a more detailed depiction of the components used to perform lensless incoherent convolutions at the speed of light according to an example embodiment of the present disclosure;

FIG. 10 illustrates a schematic diagram of an example apparatus according to an example embodiment of the present disclosure; and

FIG. 11 illustrates a flowchart of the operations for a reconfigurable optical device for deep-network inference according to an example embodiment of the present disclosure.

### DETAILED DESCRIPTION

Some example embodiments of the present disclosure will now be described more fully hereinafter with reference to the accompanying drawings, in which some, but not all embodiments of the invention are shown. Indeed, various embodiments of the disclosure may be embodied in many different forms and should not be construed as limited to the example embodiments set forth herein; rather, these example embodiments are provided so that this disclosure will satisfy applicable legal requirements. Like reference numerals refer to like elements throughout.

Embodiments of the present disclosure include a reconfigurable optical device for deep network inference. The architecture of example embodiments employs a series of low power displays to perform lensless incoherent convolutions at the speed of light. A single implementation of an example device includes inexpensive micro-displays, an active-pixel sensor, and a single board computer which are low-cost components that cost a fraction of other optical processing approaches for deep learning. The time taken for inference can, in some embodiments, decrease the efficiency in some embodiments. Embodiments provide the ability to scale downward on power consumption at the expense of Poisson noise. Devices can scale to multiple network layers. Embodiments can act both as a camera and a computer by both capturing and processing an image as described herein.

To retain the expanding impact of deep networks it is crucial to provide inference at scale and low-cost. Optical approaches for performing convolutions have a long history and have seen a resurgence. These techniques are low-power, parallel, and fast (e.g., computing at the speed of light). Provided herein is an optical convolution unit that employs inexpensive and widely available components such as micro-scale displays. Embodiments are relatively easy to assemble, extend, and use. Embodiments enable deep learning inference on low-power and inexpensive platforms.

A system of example embodiments performs incoherent convolutions between a backlit display and a transparent display placed in the optical path of a bare, lensless camera. The computationally burdensome convolutions are performed optically at the speed of light. The output of the camera is processed using a processor enabling non-linearities and other functions before being looped back to the backlit display.

The multilayer loop of example embodiments enables networks of arbitrary sizes up to the limits of local memory. The incoherent nature of the system enables a “first capture” of a scene directly before the loop beings making embodiments both a camera and a processing unit. The system is reconfigurable since the patterns on both the transparent and backlit displays can be changed. Similarly, operations that occur in software, such as batch normalization, pooling, etc. permit flexibility.

Embodiments include incoherent micro-displays manufactured for mobile platforms (e.g., for human viewing) have low refresh rates compared to other spatial light modulators. As such, embodiments provide a new trade-off in the design space of optical computing units for learning where speed is exchanged for lower cost. Embodiments provide a novel design for optical computing for inference. Embodiments are generally inexpensive compared to both conventional silicon graphics processing units and other optical alternatives.

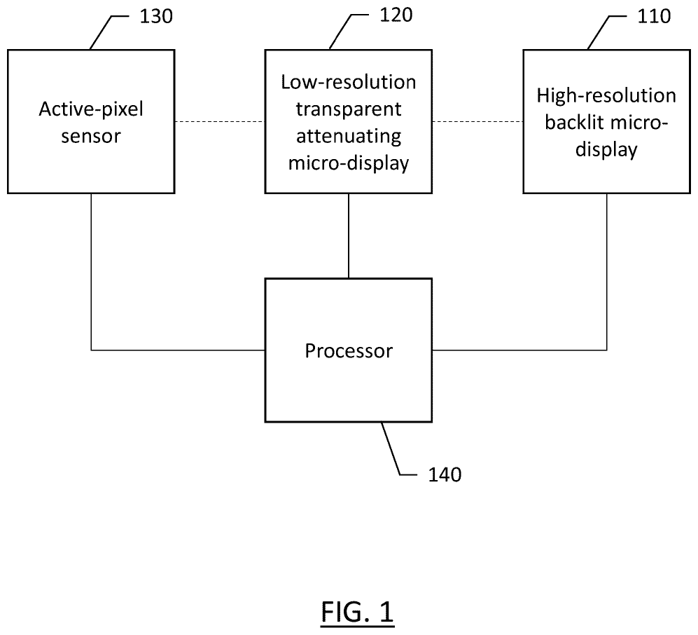

The system described herein provides a hybrid electronic component between layers that enables non-linear effects with a low-power, inexpensive solution. FIG. 1 is a block diagram of an example hybrid electro-optical convolutional device. The reconfigurable device includes four primary components to implement optical convolutions at the speed of light for incoherent light sources. The depicted components include: a backlit micro-display 110, a transparent, attenuating micro-display 120, an active-pixels sensor 130, and a processor 140. The optical path is represented by the dashed lines. The interaction of patterned light emitted from the backlit display and the convolutional kernels shown on the transparent non-emissive display yield spatial convolutions at a corresponding imaging plane. The sensor is placed at the imaging plane to capture the response. Some discrepancies may be observed in the convolutional responses when comparing them to idealized responses. These can be caused by defects in the displays, improperly spaced components, and other factors. Embodiment employ fine-tuning to improve network accuracy with these sensed convolutional responses. The backlit micro-display 110 is used to display feature maps for a given model layer. The transparent attenuating micro-display 120 is used to display the kernels for a given model layer.

An example embodiment can include a five-inch 800×480 pixel 30 frames-per-second (FPS) thin-film transistor (TFT) liquid crystal display (LCD) module as the feature map display which can be placed around 25 millimeters away from the kernel display. The second embodiment can employ a 2.8-inch 240×320 pixel 15 FPS TFT LCD module as the feature map display placed 7 millimeters away from the kernel display. For both embodiments, the kernel map display can include a monochrome 2.4-inch 128×64 pixel 3 FPS transflective graphic LCD module made transparent by removing the reflective film and replacing it with a piece of polarizing film. Both embodiments can employ a ⅔-inch Sony® CMOS Pregius IMX250 global shutter image sensor. The processor can be, for example, a Raspberry Pi controller to control the displays and sensor.

The time throughput of embodiments described herein depends on the refresh rates of the display modules and the framerate of the image sensor. The minimum exposure that is possible with the system is established by the slowest device:

$${h}_{min} = min ( {K}_{hz} , {FM}_{hz} , {S}_{hz} ) , \qquad ( 1 )$$

Where K_{hz} is the kernel screen refresh rate, FM_{hz} is the feature map screen refresh rate, and S_{hz} is the camera framerate. The minimum exposure is

$${e}_{min} = \frac{1}{{h}_{min}} .$$

Exposures greater than this can slow down computation, collect more light, and reduce Poisson noise.

The optical design can tile multiple kernels and feature maps together since convolutions can happen in parallel. As an example, let the multiplicative factor due to this packaging be ρ_{K}. Therefore, the total number of convolutions given by the device is

$$OPS ∝ \frac{{ρ}_{K}}{e}$$

where OPS is the operations-per-second of a comparable computing architecture.

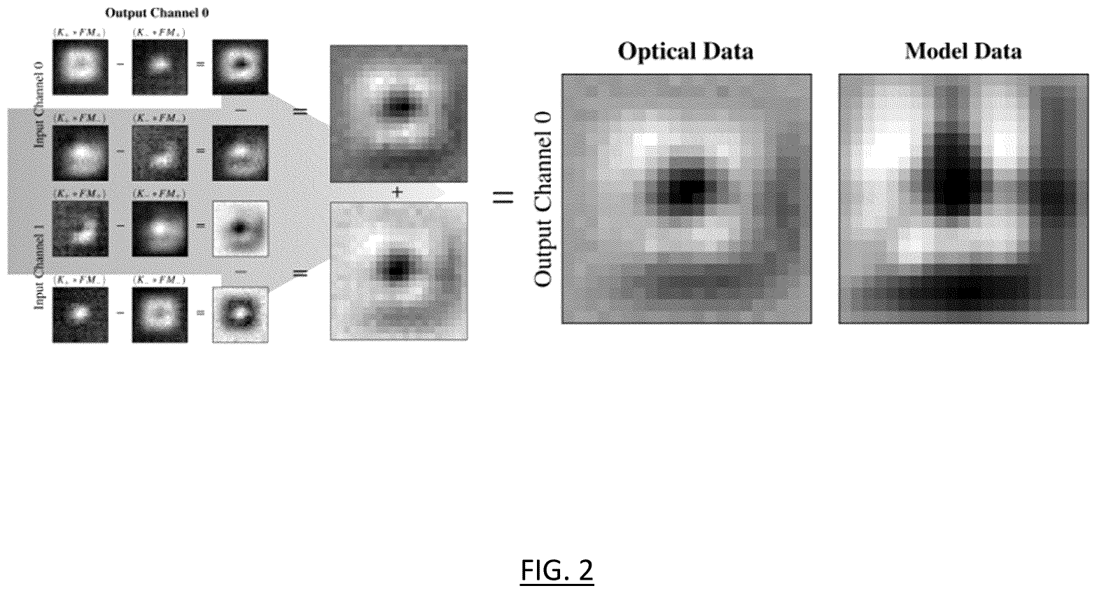

The intensity of an image cannot be less than zero, so the values of kernel image I_{K} and feature map image I_{FM} are constrained to [0, ∞). The values are further constrained by the lower noise limit of the system and the upper light intensity that the system can produce, (Iₘᵢₙ, Iₘₐₓ). When mapped between the optical convolutions and digital convolutions, the positive and negative parts of the kernel K and feature map FM are first split. Each convolution happens optically and subtraction occurs in software as shown in FIG. 2. To account for negative values and an arbitrary number of channels, multiple convolutional responses are captured then combined in pos-processing. For example in an embodiment there are two input channels and two output channels for each convolutional layer. The breakdown for one output channel is shown in FIG. 2. First, the convolutions for each combination of the positive and negative slices of K and FM are captured and combined. The final summation is done according to the machine learning library PyTorch's implementation of Conv2d which is the 2D convolution layer.

In consideration of ratio versus volume, a desired convolution implemented in software is ported to optics. The ratio, in pixels, between the software implementation of kernel size Kₚₓ and feature map size FMₚₓ is given by

$${r}_{px} = \frac{{K}_{px}}{{FM}_{px}} .$$

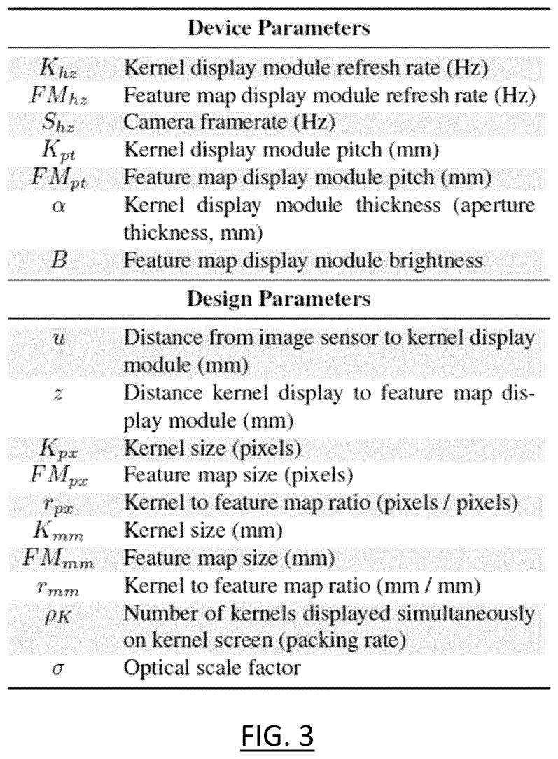

This ratio must match the physical ratio in the device given by

$${r}_{mm} = \frac{{K}_{mm} ( σ )}{{FM}_{mm}} ,$$

where the sizes of the kernel and feature maps are in millimeters, respectively given by Kₘₘ and FMₘₘ. The optical ratio also contains a perspective scaling factor σ due to the physical distances between the image sensor, kernel display, and feature map display given by:

$$σ = \frac{u + z}{u} , \qquad ( 2 )$$

Where the distance between the image sensor and kernel display is represented by u, and the distance between the kernel display and feature map display is represented by z. The table of FIG. 3 details variables employed in the design of devices described herein.

To properly port convolutions to optics, the ratios should be equal, rₚₓ=rₘₘ. The value of z is solved for that enables this as

$$z = \frac{{r}_{p x} F {M}_{m m} u}{{k}_{m m}} - u .$$

The volume of the system is then proportional to the 2D area given by (z+u)*FMₘₘ. If the volume becomes prohibitively large, a software adjustment can be found by using dilated convolutions. In such a case, the dilation factor l induces a ratio

$${r}_{p x} = \frac{l {K}_{p x}}{F {M}_{p x}} ,$$

and l is solved for given a desired fixed z.

Convolutions are the basic building blocks of convolutional neural networks (CNNs). Without loss of generality, the following description relates primarily to two-dimensional convolutions. Since these transformations are linear, any dimensional convolution can be broken up into sets of 2D convolutions that can be added together. The 2D convolution of a kernel image I_{K} and the feature map image I_{FM} are represented as:

$$\begin{matrix}{I}_{conv} ( x , y ) = {I}_{K} ( x , y ) * {I}_{FM} ( x , y ) \\ = {{\int }^{∞} \int }_{{τ}_{1} , {τ}_{2} = 0} {I}_{K} ( {τ}_{1} , {τ}_{2} ) \cdot {I}_{FM} ( x - {τ}_{1} , y - {τ}_{2} ) d {τ}_{1} d {τ}_{2} .\end{matrix} \qquad ( 3 )$$

Poisson noise, or shot noise, always occurs when measuring light, but is dominant in low-light imaging. To reduce power requirements, it is desirable to run embodiments with the lowest amount of light possible. Further, low exposure is desirable to increase speed. These two factors reduce the number of photons converted into measurable current for a given image. Shot noise follows a Poisson distribution, and the probability that k photons hit the sensor is given by:

$$P ( X = k ) = \frac{{λ}^{k} {e}^{- λ}}{k !} \qquad ( 4 )$$

Where λ is the expected value of the variable X. This is generally proportional to the intensity of the light source.

The proportionality factor ρ_{B} which can be considered as an unknown “pixels to photons” constant factor that depends on the display brightness B. The expected number of photons can be set to relate to the intensity of the feature map image displayed on the backlit display as:

$$λ = {ρ}_{B} * {I}_{FM} ( x - {τ}_{1} , y - {τ}_{2} ) \qquad ( 5 )$$

The convolution equation can be augmented using the Poisson distribution as:

$${I}_{conv} ( x , y ) = {{\int }^{∞} \int }_{{τ}_{1} , {τ}_{2} = 0} C \cdot {I}_{FM} ( x - {τ}_{1} , y - {τ}_{2} ) \cdot {I}_{K} ( {τ}_{1} , {τ}_{2} ) ) d {τ}_{1} d {τ}_{2} \qquad ( 6 )$$

Where the term C is the cumulative distribution of the Poisson distribution. It is given by

$${\sum }_{i}^{{N}_{e}} P ( X = i * ϕ ) ,$$

where P(X=i*ϕ) is the probability of i*ϕ photons with expected value λ, ϕ is the photon flux (photons per unit time and Nₑ is an integer that depends on the exposure e of the sensor and the time unit selected.

Poisson noise added in simulation to the output of each convolution layer. Eventually, all networks are degraded to the dataset prior. Binary CNNs are more robust to this noise. The noised added ranges from zero to the amplitude (x-axis). The model accuracy is measured over the test set. The first column (FNF models) represents binary convolutional neural network (BCNN) models trained on a combination of Labeled Faces in the Wild dataset and CIFAR-10 data for the classes “Face” or “Not Face”. The CNN models are basic convolutional neural networks trained on the Brain Tumor Classification (MRI) dataset. The classes are four different types of tumors. ResNet50 and DenseNet161 use the pretrained weights from PyTorch and are tested on ImageNet.

The Cumulative term

$$C = {\sum }_{i}^{{N}_{e}} P ( X = i * ϕ )$$

varies as following: if the number of trials increases (or the brightness, e.g., power of the display increases) this number approaches 1 and the convolution equation resembles a conventional convolution. In a low-light scene, the cumulative term C can change the value of the convolution. In an extreme case, if the scene is very dark with low exposure, the probabilities will all be low and the output of the convolution will be near zero.

A worst case bound can include a case due to the effects of Poisson noise in optical convolution. Consider the lowest light intensity across all feature maps in all layers of a network

$${I}_{F M}^{l o w} ( x - {τ}_{1} , y - {τ}_{2} ) ,$$

which can be shortened as I_{low}. This value correlates to the smallest pixel value across all feature maps in all layers of a network in software. The variable cumulative term C can be placed with the term corresponding to the lowest value I^{low}, which induces the Poisson distribution P corresponding to the lowest expected value

$${λ}_{l o w} = {ρ}_{B} * {I}_{F M}^{l o w} ( x - {τ}_{1} , y - {τ}_{2} ) .$$

Given a camera exposure e, this induces the lowest cumulative factor C_{low} which is a constant unlike the variable cumulative term C and can be removed from the convolution equation:

$${I}_{conv} ( x , y ) = {C}_{low} \cdot ( {I}_{K} ( x , y ) * {I}_{FM} ( x , y ) ) \qquad ( 7 )$$

The impact of this factor C_{low} depends on the non-linear activations that are applied after each convolutional layer. The activations, such as ReLU and tanh are usually monotonic in most regions, except when they cross the zero mark or contain a discontinuity. The robustness of a neural network is defined to be a pair of values (R, r). R is the maximum percentage of such activation “flips” that can be tolerated before classification rate falls below r on a dataset D.

A bound on the noise is specified given the overall neural network function C_{low} and a desired classification rate r which specifies the lowest feature map value in the backlit display

$${I}_{F M}^{l o w}$$

such that:

$$\frac{{\sum }_{i}^{\vert D \vert} V ( i )}{\vert D \vert} \geq r , s . t . V ( i ) = \{ \begin{matrix}1 , & if {f}_{low} ( {x}_{i} , {W}_{i} ) = {y}_{i} \\ 0 , & otherwise\end{matrix} \qquad ( 8 )$$

Where the indicator function V tests the effect of the learned overall network function ƒ and ƒ_{low} is the implementation of the network where every convolution is reduced by the factor C_{low} before the application of non-linearity.

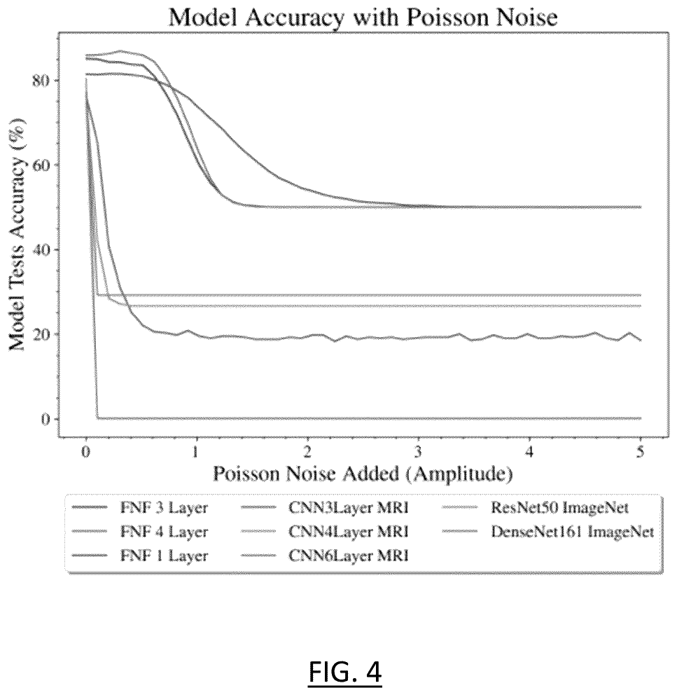

FIG. 4 illustrates the effect on classification due to simulated Poisson noise effect on a variety of deep networks including standard architectures such as DenseNet and ResNet. The Poisson noise was steadily increased on every convolution in the network until the est accuracy reached the dataset prior. The effect of Poisson noise on convolutions is more severe for conventional networks than binary CNNs, denoted as FNF (Face Not Face model) in the figure. This is another advantage of using binary CNNs on embodiments described herein.

Embodiments of the present disclosure are implemented using inexpensive liquid crystal displays with the transparent screen used being a monochrome (binary) graphic display module. Embodiments target inference for binary convolutional networks. A quantization approach is considered for specifying the filters. The filters in the network are composed of binary tensors that are modulated by a floating-point scalar per channel to permit specifying complicated decision surfaces. The binary weights can be discerned via back-propagation-based gradient descent. The weights are binarized by computing and using the sign of the weight magnitude, which is an optimal solution to a constrained least-squares problem. The scalar values can be determined during training by also optimizing a least squares problem. This problem has a closed-form solution which is the average of the absolute values of the filter weights.

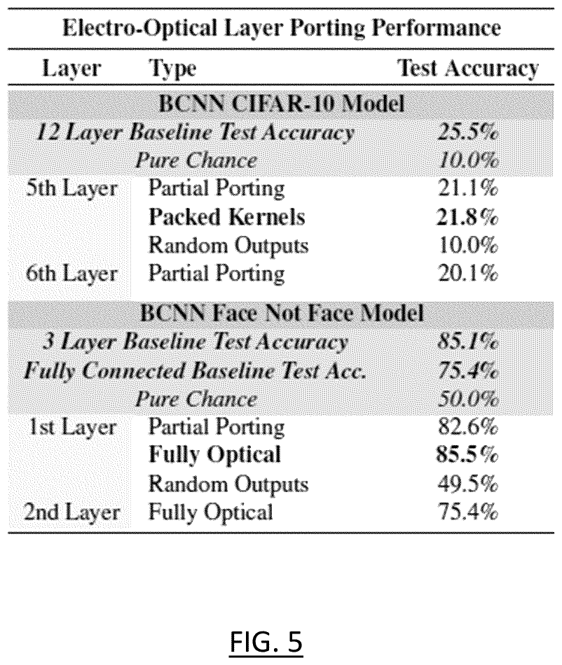

Using binary weights and feature maps for optical convolutions maximizes contrast and improves the convolutional accuracy. This reduces the amount of post-processing needed in software. Another advantage of binary CNNs is that it lowers the overall device bandwidth. Binary CNNs have reduced representation capability compared to conventional CNNs. Further, binary CNNs are investigated with only two channels to expedite testing on example embodiments. These small binary-only networks may have lower baseline accuracy than conventional large CNNs. Embodiments focus on comparing optical computing device with conventional software implementations. This shows the relative comparison between optical and conventional implementations of small binary CNNs. The table of FIG. 5 represents the baseline software binary CNN test accuracies.

During inference, pre-trained feature maps and kernels are shown on their respective displays and the resulting convolutional response is imaged. The images are run through a post-processing algorithm to account for negative values and the number of channels (as shown in FIG. 2) then appropriately downsized to match the model's expected layer output size. The discretized convolution image equation is:

$${I}_{conv} ( x , y ) = Π ( x , y , α ) \cdot {\sum }_{{n}_{1} , {n}_{2} = 0}^{{K}_{px} , {FM}_{px}} ( {I}_{K} ( {n}_{1} {K}_{pt} , {n}_{2} {K}_{pt} ) \cdot {I}_{FM} ( ( x - n 1 ) {FM}_{pt} , ( y - n 2 ) {FM}_{pt} ) ) \qquad ( 9 )$$

Where Π(x, y, a) represents the aperture vignetting factor due to the display screen thickness [ ] and the convolution occurs with discrete steps of n₁ and n₂ that are modulated by the pixel pitches Kₚₜ and FMₚₜ of the kernel and feature map displays respectively.

According to an example embodiment, a single layer in a CNN is ported onto the device. Porting a single layer to optics is done by sandwiching the optical layer between software generated layers. The inputs displayed on the device are the software generated outputs of the previous layer. The optically generated outputs are then sent to the next software layers. The network of an example embodiment is a 12-layer binary convolutional neural network trained on the CIFAR-10 dataset. The model is trained such that the fifth convolutional layer has fewer channels and can be ported onto the optical device relatively quickly. This layer has a dilation factor of 4, a 3×3 kernel, and 11×11 feature map. Softmax is used to constrain the values between 0 and 1, to account for discrepancies between the value range of the optically captured convolutional response data and the software generated model data that could occur with other activation functions like ReLU. The test for CIFAR-10 has 10,000 images, and due to the need to process negative and positive separately, 160,000 images need to be captured by embodiments of the present device.

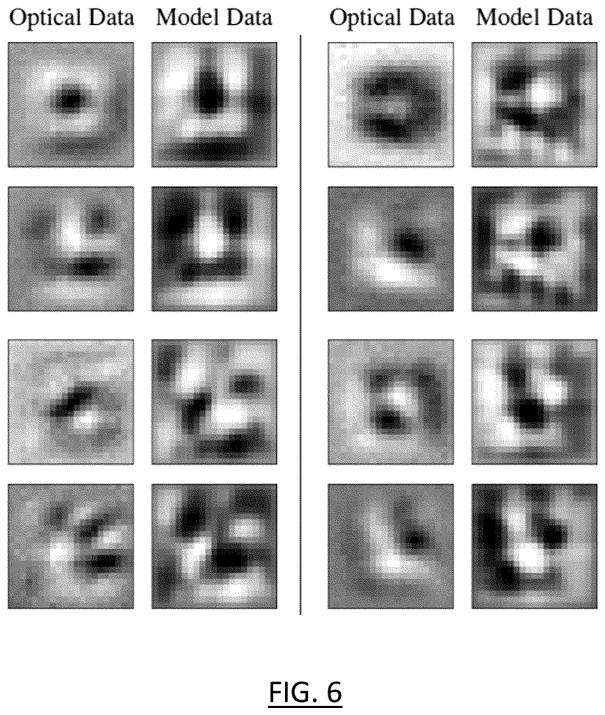

FIG. 6 illustrates the combined optical outputs from an example device compared to the software outputs of convolutions from the BCNN CIFAR-10 model. Notably, each of these outputs is the result of multiple convolutions over multiple channels. The device of example embodiments closely matches the software outputs in many scenarios. To overcome any differences that do occur a fine-tuning process may be applied.

Pure chance accuracy for the CIFAR-10 dataset is 10%. Training the network in software gives an accuracy of 25.5%. Porting the fifth layer weights from software to optics results in a fall in software test accuracy, which can be pushed up by fine-tuning the software layers after the optically implemented layer. To implement the fine-tuning of an example embodiment 20% of the optically captured data is used and numbers reported on the remaining 80%, which increased accuracy to 21.1%.

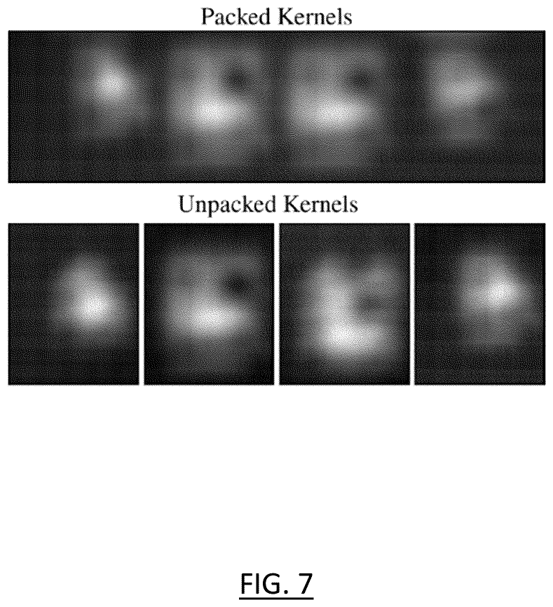

Optical processing has a parallelism advantage if multiple convolutions are captured simultaneously. Embodiments described herein enable this through simultaneous display of kernels. As shown in FIG. 7, one row from a 2×4=8 array for a particular input is shown and compared to individual convolutions. The top row illustrates an example of simultaneously captured convolutions with four kernels packed together. The individual sequentially captured convolutional responses are shown in the bottom row. Packing kernels together enables the capture of fewer images which speeds up processing while reducing power consumption.

The fifth binary convolution layer previously ported can be ported faster without losing test accuracy using the method described herein. After splitting the kernels for this layer into their positive and negative halves, eight kernel images can be displayed at once for each feature map image. This drastically reduces the number of images captured from 160,000 images originally to 40,000 images with multiple kernels. The same fine-tuning described above can be performed to obtain a test accuracy of 21.8%.

As described above, fine-tuning optical layers results in a slight fall in accuracy when compared to the baseline accuracy. Overcoming this is crucial when dealing with multi-layer implementations since the accumulated error across multiple optical layers can become large. Addressing this issue requires training weights on the optical device itself. While backpropagation into the optical weights is the correct solution, it requires multiple passes on the optical device which can be slow given the low refresh rate. Instead, embodiments employ an approach based on a modified version of layer-wise fine-tuning where fine-tuning happens in software.

According to an example embodiment, one layer has been ported onto the device. The remaining layers are then fine-tuned in software with a portion of the collected optical data. After fine-tuning, the weights of the next layer are ported to optics and the process is repeated until all layers are ported onto the device. The table shown in FIG. 5 illustrates experimental results for this process for what is termed as a Face Not Face model which is a binary convolutional neural network trained as a binary classifier between Labeled Faces in the Wild (“Face”) and CIFAR-10 images (“No Face”) with a test set of 7,416 images. The network consists of up to three binary convolution layers (16×16 kernels, 32×32 feature maps) followed by a fully connected layer. Each layer has two input and two output channels, excluding the first layer which has three input channels. The table demonstrates that fully optical approaches beat or equal sending images directly to a fully connected layer in software. Optics adds usefulness to the inference without consuming much extra power. In the table of FIG. 5, the Partial Porting rows detail the test accuracies of porting each specified layer after fine-tuning. The Fully Optical rows represent the test accuracy of training a fully connected layer on the captured data for a given layer. The packed kernels is the test accuracy after fine-tuning for a given layer ported with multiple kernels displayed at once. Random Outputs is the resulting test accuracy when the output of that layer is replaced with random values.

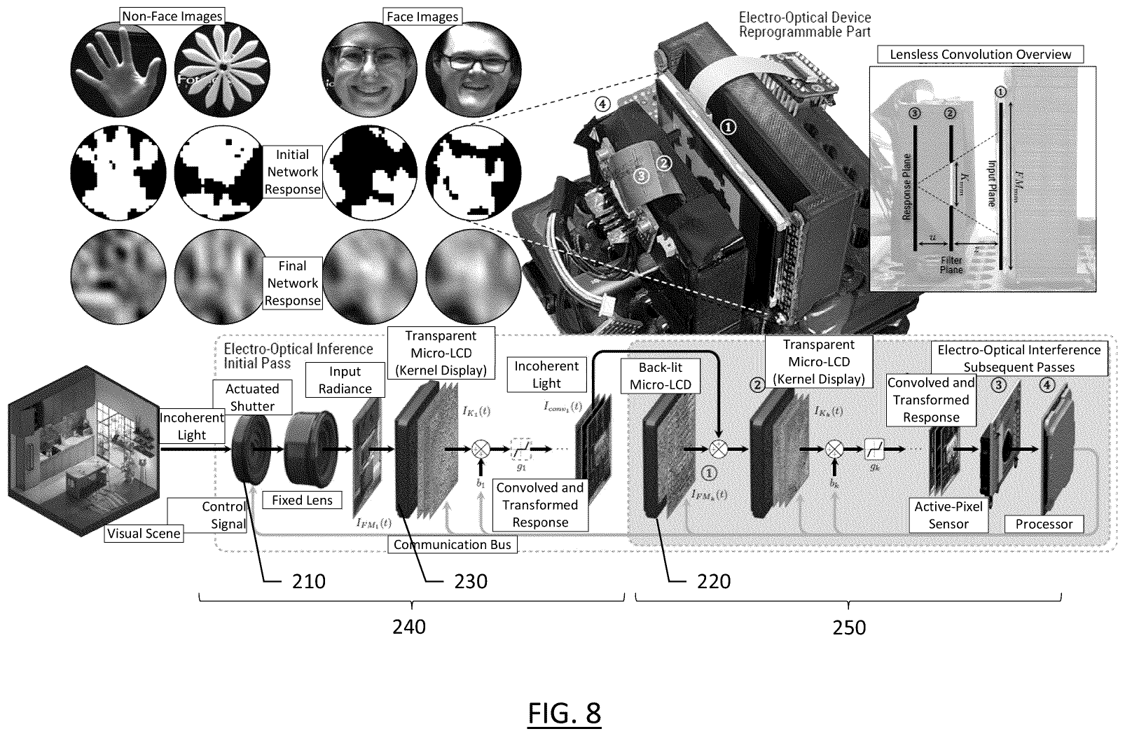

The device of example embodiments described herein enables low-cost and low-light processing of incoherent light. This is in sharp contrast to other optical processing techniques and enables image capture and processing from real scenes. FIG. 8 illustrates a ray diagram of an example embodiment of the disclosed system coupled with normal camera optics. When the camera shutter 210 is open, the backlit display 220 is off and the transparent display 230 is completely open, creating an imaging system. When the camera shutter 210 closes, the system resembles the original device described above. Captured images are pre-processed for a target network and displayed on the backlit display 220 while the transparent display shows the corresponding network kernels. Using the Face No Face model, the device of FIG. 8 can be used as a camera for both an imaging device and as a computer as described above.

The computer to perform lensless incoherent convolutions at the speed of light embodied in a camera as shown in FIG. 8 employs the disclosed electro-optical device as a reconfigurable computational camera that possesses adaptive inference. An example application of this camera can be used for face detection. The small-scale networks used on the disclosed hybrid electro-optical device form consistent final feature maps that encode well the presence and non-presence of faces in complex visual scenes. The feature maps for the two chosen faces are highly consistent despite distinct changes in illumination and face shape. A high-level ray diagram that shows the flow of incoherent light through the device is depicted in the top right of FIG. 8. A beam splitter can be inserted between the input plane and the filter plane to aggregate incident scene light. A high-level overview of how scene content is illustrated along the bottom of FIG. 8. There is a two-stage processing pipeline. The first stage 240 is composed of optical components that transforms scene radiance. Such components compute at the speed of light with microwatt-scale power draws. The second stage 250 is composed of electro-optical components that further transform the scene radiance to produce a final response. These components operate in the milliwatt-scale range.

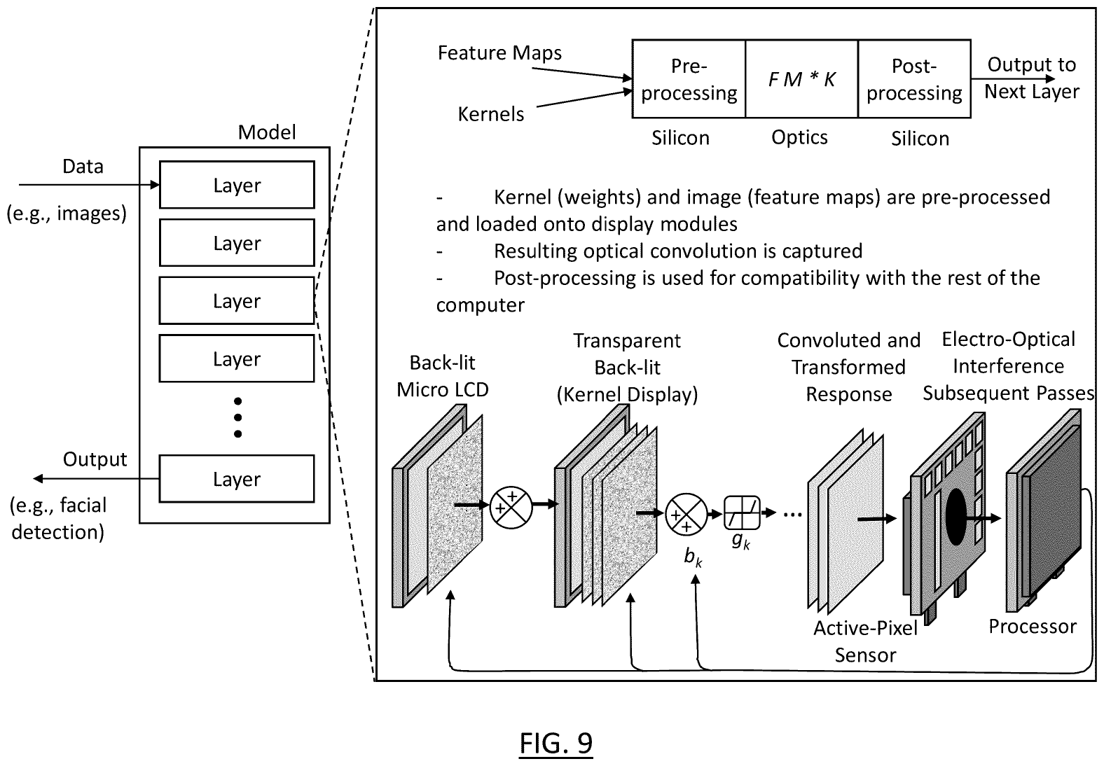

FIG. 9 illustrates a more detailed depiction of the components used to perform lensless incoherent convolutions at the speed of light. As shown, the feature maps and kernels are input into a layer where there is pre-processing, optics, and post-processing before being forwarded to the next layer. The optics provide for display of the kernel and image and the resulting optical convolution is captured as described above. The output of the layers is the result of the BCNN, such as facial detection.

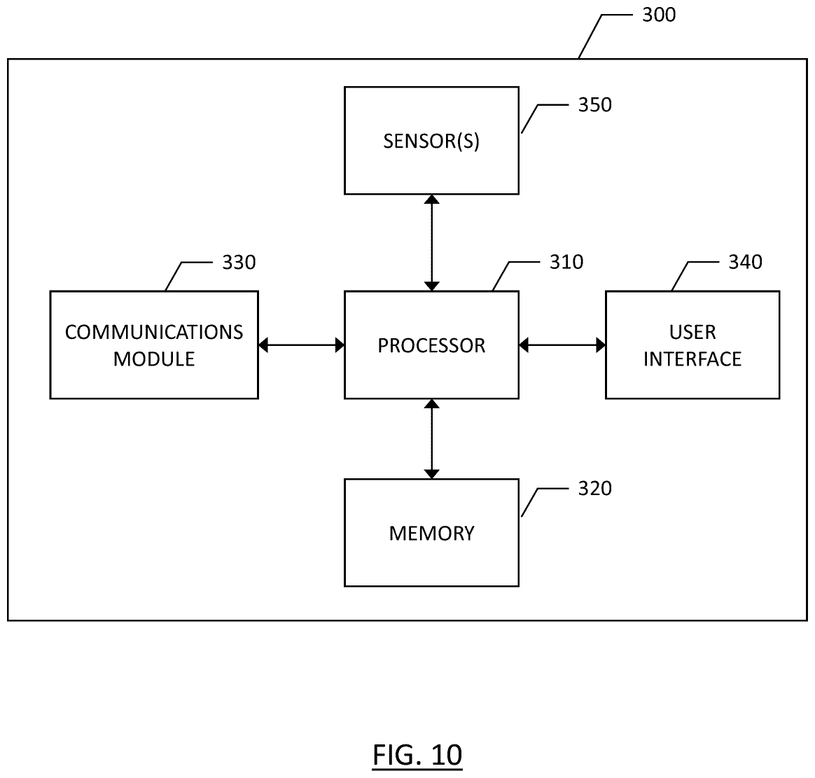

Embodiments of the computer to perform lensless incoherent convolutions at the speed of light described above can be controlled by an apparatus, such as the apparatus of the schematic diagram of FIG. 10 of an example of an apparatus 300 configured to perform procedures as described herein. The apparatus 300 can be a Raspberry Pi controller and in some embodiments, simply the processor 310 of the apparatus. In other embodiments, the device of example embodiments is embodied as part of a larger apparatus to perform lensless incoherent convolutions to develop an output based on the input image data. The apparatus 300 may include or otherwise be in communication with a processor 310, a memory 320, a communication module 330, a user interface 340, and sensor(s) 350 which can include an image capture sensor or an actuated shutter, for example. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

In some embodiments, the processor 310 (and/or co-processors or any other processing circuitry assisting or otherwise associated with the processor) may be in communication with the memory 320 via a bus for passing information among components of the apparatus. The memory 320 may include, for example, one or more volatile and/or non-volatile memories. In other words, for example, the memory 320 may be an electronic storage device (e.g., a computer readable storage medium) comprising gates configured to store data (e.g., bits) that may be retrievable by a machine (e.g., a computing device like the processor). The memory 320 may be configured to store information, data, content, applications, instructions, or the like for enabling the apparatus 300 to carry out various functions in accordance with an example embodiment of the present disclosure. For example, the memory 320 could be configured to buffer input data for processing by the processor 310. Additionally or alternatively, the memory could be configured to store instructions for execution by the processor.

The processor 310 may be embodied in a number of different ways. For example, the processor 310 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor 310 may include one or more processors configured in tandem via the bus to enable independent execution of instructions, pipelining and/or multithreading.

In an example embodiment, the processor 310 may be configured to execute instructions stored in the memory 320 or otherwise accessible to the processor 310. Alternatively or additionally, the processor 310 may be configured to execute hard coded functionality. As such, whether configured by hardware or software methods, or by a combination thereof, the processor 310 may represent an entity (e.g., physically embodied in circuitry) capable of performing operations according to an embodiment of the present invention while configured accordingly. Thus, for example, when the processor 310 is embodied as an ASIC, FPGA or the like, the processor 310 may be specifically configured hardware for conducting the operations described herein. Alternatively, as another example, when the processor 310 is embodied as an executor of software instructions, the instructions may specifically configure the processor 310 to perform the algorithms and/or operations described herein when the instructions are executed. However, in some cases, the processor 310 may be a processor of a specific device configured to employ an embodiment of the present invention by further configuration of the processor 310 by instructions for performing the algorithms and/or operations described herein. The processor 310 may include, among other things, a clock, an arithmetic logic unit (ALU) and logic gates configured to support operation of the processor 310. In one embodiment, the processor 310 may also include user interface circuitry configured to control at least some functions of one or more elements of the user interface 340.

The communication module 330 may include various components, such as a device or circuitry embodied in either hardware or a combination of hardware and software that is configured to receive and/or transmit data for communicating data between the apparatus 300 and various other entities, such as a teleradiology system, a database, a medical records system, or the like. In this regard, the communication module 330 may include, for example, an antenna (or multiple antennas) and supporting hardware and/or software for enabling communications wirelessly. Additionally or alternatively, the communication module 330 may include the circuitry for interacting with the antenna(s) to cause transmission of signals via the antenna(s) or to handle receipt of signals received via the antenna(s). For example, the communications module 330 may be configured to communicate wirelessly such as via Wi-Fi (e.g., vehicular Wi-Fi standard 802.11p), Bluetooth, mobile communications standards (e.g., 3G, 4G, or 5G) or other wireless communications techniques. In some instances, the communications module 330 may alternatively or also support wired communication, which may communicate with a separate transmitting device (not shown). As such, for example, the communications module 330 may include a communication modem and/or other hardware/software for supporting communication via cable, digital subscriber line (DSL), universal serial bus (USB) or other mechanisms. For example, the communications module 330 may be configured to communicate via wired communication with other components of a computing device.

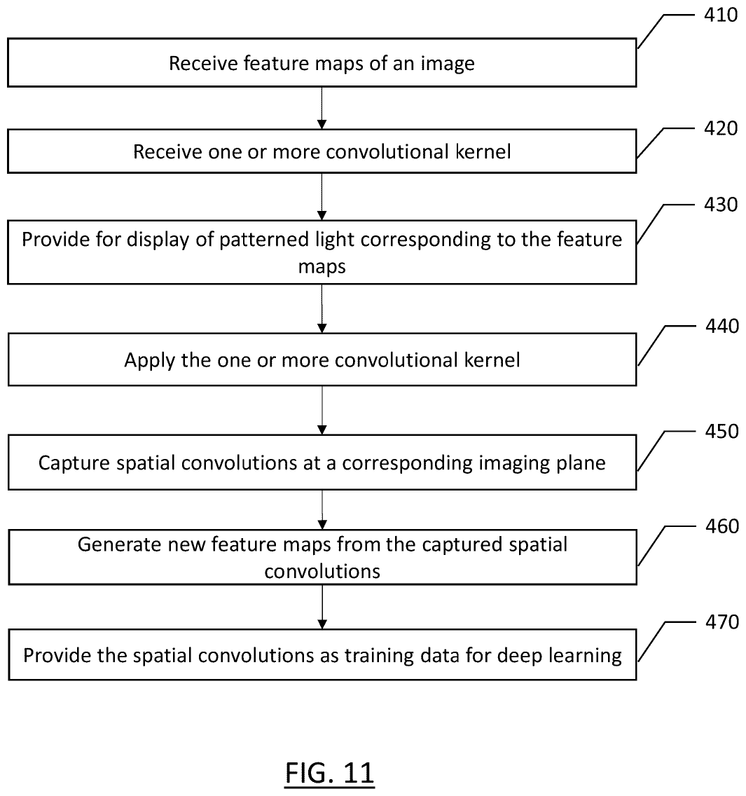

FIG. 11 illustrates a flowchart of a method according to an example embodiment of the disclosure. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory 320 of an apparatus employing an embodiment of the present invention and executed by the processor 310 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

According to the flow chart of FIG. 11, feature maps of an image are received at 410. One or more convolutional kernels are received at 420. Patterned light is provided for display at 430 corresponding to the feature maps. The one or more convolutional kernel is applied at 440. Spatial convolutions are captured at a corresponding imaging plane at 450. New feature maps can be generated from the captured spatial convolutions as shown at 460. The spatial convolutions are provided as training data for deep learning at 470. The new feature maps can be displayed in patterned light and with one or more convolutional kernels applied to capture new spatial convolutions at a corresponding image plane. The new spatial convolutions can be provided as training data for deep learning as a recursive loop to benefit from a multitude of new training data produced at a relatively low processing cost.

In an example embodiment, an apparatus for performing the method of FIG. 11 above may comprise a processor (e.g., the processor 310) configured to perform some or each of the operations (410-470) described above. The processor may, for example, be configured to perform the operations (410-470) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 410-470 may comprise, for example, the processor 310 and/or a device or circuit for executing instructions or executing an algorithm for processing information as described above.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. An apparatus comprising processing circuitry and at least one memory including computer program code, the at least one memory and the computer program code configured to, with the processing circuitry, cause the apparatus to at least:
receive feature maps of an image;
receive one or more convolutional kernel;
provide for display of patterned light corresponding to the feature maps;
apply the one or more convolutional kernel;
capture spatial convolutions at a corresponding imaging plane;
generate new feature maps from the captured spatial convolutions; and
provide the spatial convolutions as training data for deep learning.

2. The apparatus of claim 1, further comprising:
provide for display of patterned light corresponding to the new feature maps;
apply the one or more convolutional kernel;
capture new spatial convolutions at a corresponding imaging plane; and
provide the new spatial convolutions as training data for deep learning.

3. The apparatus of claim 1, wherein causing the apparatus to provide for display of the patterned light corresponding to the feature maps comprises causing the apparatus to provide for display of the patterned light on a backlit display.

4. The apparatus of claim 3, wherein causing the apparatus to apply the one or more convolutional kernel comprises causing the apparatus to apply the one or more convolutional kernel at a transparent non-emissive display.

5. The apparatus of claim 4, wherein causing the apparatus to capture the spatial convolutions at the corresponding imaging plane comprises causing the apparatus to capture the spatial convolutions at a processor.

6. The apparatus of claim 1, wherein the apparatus is further caused to:
train at least one machine learning model based, at least in part, on the spatial convolutions.

7. The apparatus of claim 6, wherein the at least one machine learning model comprises a facial detection model.

8. The apparatus of claim 1, wherein causing the apparatus to receive the feature maps of the image comprises causing the apparatus to pre-process the feature maps and load the feature maps onto a display module.

9. The apparatus of claim 8, wherein causing the apparatus to receive the one or more convolutional kernel comprises causing the apparatus to pre-process the one or more convolutional kernel and load the one or more convolutional kernel onto another display module.

10. The apparatus of claim 9, wherein causing the apparatus to provide the spatial convolutions as training data for deep learning comprises causing the apparatus to post-process the captured spatial convolutions for compatibility with at least one machine learning model.

11. A system for deep network inference comprising:
a back-lit micro display;
a transparent display;
an active pixel sensor; and
a processor,
wherein the back-lit micro display provides for display of a feature map of a captured image, wherein the transparent display provides for display of a kernel, and wherein the active pixel sensor captures a convoluted and transformed response.

12. The system of claim 11, wherein the processor provides for post-processing of the convoluted and transformed response to format the convoluted and transformed response to be compatible with a deep learning model.

13. The system of claim 12, wherein the deep learning model comprises a facial detection model.

14. The system of claim 11, wherein the back-lit micro display, the transparent display, and the active pixel sensor are arranged along an optical axis.

15. The system of claim 14, wherein the active pixel sensor detects the feature map of the captured image displayed on the back-lit micro display through the transparent display displaying the kernel to capture the convoluted and transformed response.

16. A method comprising:
receiving feature maps of an image;
receiving one or more convolutional kernel;
providing for display of patterned light corresponding to the feature maps;
applying the one or more convolutional kernel;
capturing spatial convolutions at a corresponding imaging plane;
generating new feature maps from the captured spatial convolutions; and
providing the spatial convolutions as training data for deep learning.

17. The method of claim 16, further comprising:
providing for display of patterned light corresponding to the new feature maps;
applying the one or more convolutional kernel;
capturing new spatial convolutions at a corresponding imaging plane; and
providing the new spatial convolutions as training data for deep learning.

18. The method of claim 16, wherein providing for display of the patterned light corresponding to the feature maps comprises providing for display of the patterned light on a backlit display.

19. The method of claim 18, wherein applying the one or more convolutional kernel comprises applying the one or more convolutional kernel at a transparent non-emissive display.

20. The method of claim 19, wherein capturing the spatial convolutions at the corresponding imaging plane comprises capturing the spatial convolutions at a processor.
